(19) United States
(12) Patent Application Publication
(10) Pub. No.: US 2013/0158685 A1
(43) Pub. Date: Jun. 20, 2013

(54) Competitive Activity Social Networking And Event Management

(71) Applicant: Wanamaker Corporation, Colorado Springs, CO (US)

(72) Inventor: Doyle James Heisler, Colorado Springs, CO (US)

(73) Assignee: Wanamaker Corporation, Colorado Springs, CO (US)

(21) Appl. No.: 13/665,423

(22) Filed: Oct. 31, 2012

Related U.S. Application Data
(60) Provisional application No. 61/577,781, filed on Dec. 20, 2011.

(51) Int. Cl. G06F 19/00

(52) U.S. Cl. 700/91

(57) ABSTRACT

A server communicates with mobile user devices over a communications network. The user devices are associated with respective players of a competitive activity, such as golf. Points scored by a scoring player are entered through an electronic scorecard on the user devices, but are accepted by only those user devices not associated with the scoring player. The server receives the points that were accepted by the user devices accumulates the scores. Current rankings of the respective players are determined from the accumulated scores and the rankings are displayed, such as through a leaderboard displayed on the user devices, upon demand by at least one of the user devices.

### RELATED APPLICATION DATA

This application claims the benefit of U.S. Provisional Patent Application Ser. No. 61/577,781, filed on Dec. 20, 2011 and entitled, “Online Sports Scoring and Social Networking System and Method,” the full disclosure of which is incorporated herein by reference.

### TECHNICAL FIELD

The present disclosure relates to managing competitive activities, including scorekeeping, via a social network service over a communication network.

### BACKGROUND

Golf clubs provide a place where members can compete and socialize with other members. Traditional brick-and-mortar golf clubs typically serve a local community of members, although some golfers may travel great distances to play a course at a certain club. In some cases, such as when a golfer wishes to play in a tournament, the participant must first travel to the golfing venue at which the tournament is being held, often over great distances and with great expense. When a player is playing in an event that is not near his/her home course or club, the player may lose the community feel that would be experienced at his/her own club. Thus, there is an apparent need for means by which players can compete and socialize even when the players and golf courses are physically separated by great distances.

However, conducting tournaments and the like over a wide area presents challenges beyond the spanning distance. Tournament play involves numerous competing players, often over several rounds of golf. Scoring in competition is accomplished by the golfers, Player 1 and Player 2, say, first exchanging scorecards. Then, after each hole, Player 1 informs Player 2 his/her score and Player 2 records the score on Player 1's scorecard. Player 1 also records his/her own score on an unofficial scorecard. Likewise, Player 2 informs Player 1 his/her score and Player 1 records the score on Player 2's scorecard. Player 2 also records his/her own score on an unofficial scorecard. After the round, each player returns the official scorecard to an officially designated player and each player checks their official scorecard against their unofficial scorecard for accuracy. If there are no discrepancies, the player attests the official scorecard and turns it into tournament officials. If a discrepancy is found, however, the players meet with the tournament officials and attempt to resolve the dispute. This can be a particularly irritating, if not impossible task, particularly if no cameras or tournament judges witnessed the strokes in question. Indeed, the hole at which the disputed strokes were played may have been played hours before the scorecard attest process.

Certain golfing events, e.g., high school, college and some competitive golf tournaments, are carried out with few resources available for anything other than paper-and-pencil scoring. Typically, spectators of such tournaments must wait hours and sometime days to see the finally scored results. Thus, there is an apparent need for scoring golf, and other competitive events, so that results are available in a shorter period of time.

### SUMMARY

A server device is communicatively coupled to a plurality of user devices through respective communication channels in a communications network. The user devices are associated with respective players of a competitive activity, such as golf. One or more points scored by a scoring player is entered through controls on the user devices, but are accepted by only those user devices not associated with the scoring player. The server device receives the points that were accepted by the user devices not associated with the scoring player and accumulated. Rankings of the respective players are determined from the accumulated scores and the rankings are displayed upon demand by at least one of the user devices.

### BRIEF DESCRIPTION OF THE DRAWINGS

FIG. 1 is a schematic block diagram of a social network system by which the present general inventive concept may be embodied.

FIG. 2 is a flow diagram of a game management process by which the present general inventive concept may be embodied.

FIGS. 3A-3C are illustrations of user interfaces that may be implemented on a mobile device in embodiments of the present general inventive concept.

FIG. 4 is an illustration of an exemplary social media member web page that may embodied by the present general inventive concept.

FIG. 5 is an illustration of an event creation web page that may embodied by the present general inventive concept.

FIG. 6 is an illustration of a golf course selection web page that may embodied by the present general inventive concept.

FIG. 7 is an illustration of a golfer invitation webpage that may embodied by the present general inventive concept.

FIG. 8 is an illustration of an exemplary sponsors' web page that may embodied by the present general inventive concept.

FIG. 9 is an illustration of an exemplary event information publishing web page that may embodied by the present general inventive concept.

### DESCRIPTION OF EXAMPLE EMBODIMENTS

The present inventive concept is best described through certain embodiments thereof, which are described in detail herein with reference to the accompanying drawings, wherein like reference numerals refer to like features throughout. It is to be understood that the term invention, when used herein, is intended to connote the inventive concept underlying the embodiments described below and not merely the embodiments themselves. It is to be understood further that the general inventive concept is not limited to the illustrative embodiments described below and the following descriptions should be read in such light.

Additionally, the word exemplary is used herein to mean, “serving as an example, instance or illustration.” Any embodiment of construction, process, design, technique, etc., designated herein as exemplary is not necessarily to be construed as preferred or advantageous over other such embodiments.

A complete understanding of the present invention does not require a clear distinction as to what is considered a sport and what is considered a game, and the terms may be used synonymously herein. That is, the present invention may be embodied for any competitive activity that has rules of play and in which points are scored by competitors in the activity, where the term point or score are generic terms used herein for any quantifiable award resulting from a competitor's play in the competition. Upon review of this disclosure, the ordinarily skilled artisan will recognize and appreciate that the principles of the present invention apply to numerous competitive activities, regardless of whether convention classifies such as sports or games, including, but not limited to, golf, tennis, baseball, football, soccer, chess and poker.

For purposes of explanation and not limitation, the embodiments herein are described primarily in the context of the game of golf and, accordingly, golf-related game playing and scoring terminology is used throughout this disclosure. The ordinarily skilled artisan will recognize analogies of the golf-related terminology used herein for activities other than golf and in which the present invention can be embodied.

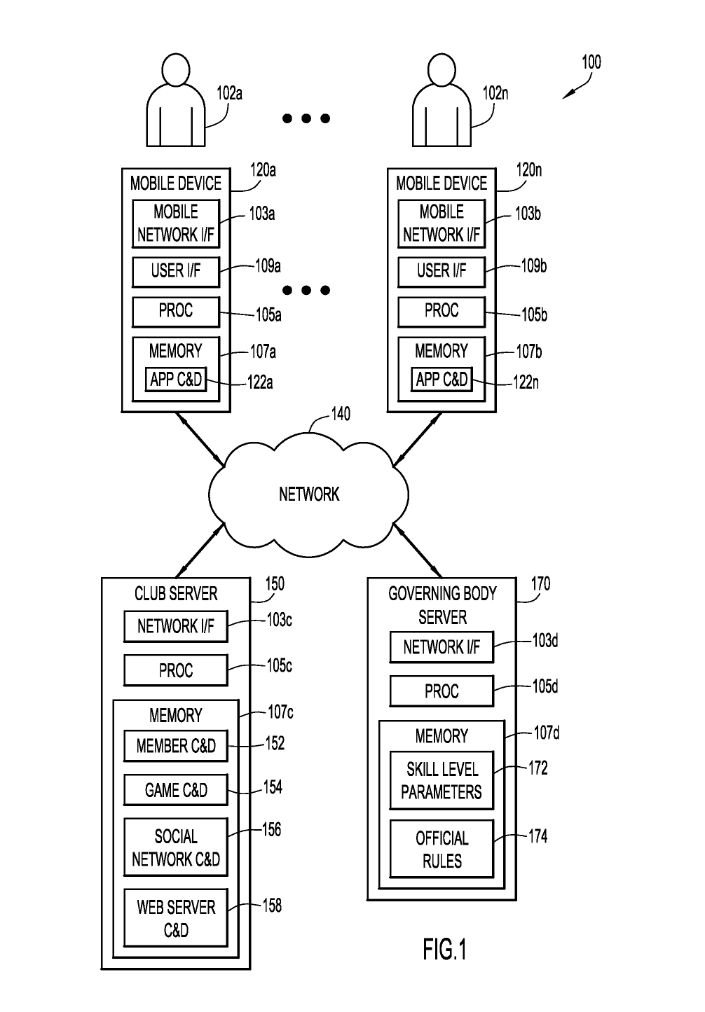

FIG. 1 is a schematic block diagram of a distributed processing system implementing a social network system 100 by which the present invention may be embodied. Social network system 100 may implement a virtual golf club by which users 102a-102n, representatively referred to herein as user(s) 102, can socialize and perform, among other things, competition management and scorekeeping tasks over network 140. As such, social networking system 100 may be alternatively referred to herein as golf club 100.

Social network system 100 includes several interoperating processing units, to be described separately below, comprising network interfaces 103a-103d, representatively referred to herein as network interface(s) 103, processors 105a-105d, representatively referred to herein as processor(s) 105, and memories 107a-107d, representatively referred to herein as memory or memories 107. Network interfaces 103 implement functionality by which the processing units communicate with one another over a communication network 140. The present invention is not limited to particular network interfaces 103, to particular media over which communications are conducted or to particular standards and/or protocols to which communications may comply. Additionally, communication network 140 may be implemented by any number of any suitable communications mechanisms and media, e.g., wide area network (WAN), local area network (LAN), wireless networking, Internet, Intranet, etc.

Processors 105 may implement data processing functionality of the respective processing units as well as control functions by which the individual processing units can both autonomously operate and interoperate with other processing units. Processors 105 may be, for example, microprocessors executing processor instructions stored in respective memories 107. In addition to processor instructions, memory 107 may also store data on which data processing operations are performed. It is to be understood that network interfaces 103, processors 105 and memories 107 may be constructed in a wide variety of fixed and programmable circuitry; the present invention is not limited to any particular implementation thereof. The ordinarily skilled artisan will readily recognize the roles of each of these elements in embodiments of the present invention upon review of this disclosure.

Social network system 100 may include a plurality of mobile processor devices 120a-120n, representatively referred to herein as mobile device(s) 120, a club server 150 and a governing body server 170. Mobile devices 120 communicate over network 140 via at least one wireless communication link through mobile network interface 103 and may be implemented by a wide variety of portable computing/communication devices such as, for example, smartphones, tablet personal computers, laptop computers and netbooks, to name but a few. Mobile devices 120 may include a user interface 109a-109b, representatively referred to therein as user interface(s) 109, to afford interactions between user 102 and features implemented on mobile device 120. Larger mobile devices 120, i.e., those with larger displays and controls on user interface 106, e.g., tablet personal computers, may be used to configure those club activities, such as golf tournaments, that would otherwise be cumbersome to configure on the smaller mobile devices 120, e.g., smartphones. However, it is to be understood that the present invention may be embodied by simplified interfaces for smaller mobile devices 120 that provide a purposed control set suited for such smaller mobile devices 120.

Embodiments of the present invention allow games of golf to be conducted across multiple venues, e.g., golf courses, by concurrently competing users 102, which may alternatively referred to herein as player(s) 102. Each player 102 may carry with him/her a mobile device 120 that is outfitted with functionality to perform game-related tasks. One such task may be to create or modify competition events and another task may be scorekeeping. These and other game-related tasks are described below.

Each user device 120 may include application code and data, illustrated at application code and data store 122 that, when executed and/or operated upon by a corresponding processor 105, implements the aforementioned task functionality. Thus, application code and data as executed by processor 105 may be referred to herein as application 122. Application 122 may provide access to other components of golf club 100 for purposes of, among other things, community interaction, game scoring and player standings tracking. For example, application 122 may implement, among other things, an electronic scorecard, an electronic leaderboard and a social media interface through which the player can interact with other players regardless of the venue at which such other players are located. Accordingly, application 122 may allow each player in a game to track the progress and scores of other players participating in the game. Additionally, application 122 may allow users to post social media comments and status updates during a game, or at other times, which may then be shared to other members. Application 122 may comprise specifically programmed processor instructions, e.g., a mobile app, a web browser or a combination thereof. Upon review of this disclosure, the ordinarily skilled artisan will recognize numerous techniques by which application 122 may be implemented without departing from the spirit and intended scope of the present invention.

Exemplary club server 150 implements core user, competition and social media management functionality of golf club 100. Processor 105c may implement such functionality through execution of code, i.e., programmed processor instructions, and operations on data stored in memory 107c. Each of member code and data store 152, game code and data store 154, social network service code and data store 156 and web server code and data store 158 maintains code and data for member management, game management, social media management and web server functions, respectively. When executed by the corresponding processor 105, each code and data store 152, 154, 156 and 158 embodies a functional processing unit and, as such, will be referred to herein as member management unit 152, game management unit 154, social network services unit 156 and web server 158, respectively. The ordinarily skilled artisan will recognize techniques, such as by programmed processor instructions, by which the functional units can be implemented upon review of this disclosure.

In certain embodiments of the present invention, golf club 100 is accessed and operated by application layer network protocols including the hypertext transfer protocol (HTTP). Suitably formatted data, such as webpages and components embedded in such webpages may be retrieved and data may be transferred between network entities under HTTP. However, it is to be understood that network protocols and data formats other than HTTP may be used in conjunction with the present invention without departing from the spirit and intended scope thereof. Exemplary web server 158 embodies web services by which users can interact with the system and with one another, such as by HTTP. The ordinarily skilled artisan will recognize the appropriate web services by which the techniques disclosed herein can be embodied without explicit description thereof and, as such, explicit description of the services will be omitted solely for purposes of conciseness.

Exemplary member management unit 152 embodies functionality to, among other things, manage club membership information, maintain user profiles of individual members, maintain user credentials, e.g., username and passwords, maintain player game statistics, and so on, essentially without limitation. Users 102 may register in a suitable manner through, for example, a web page, such as by providing any or all of a name, address, email address, username, password, public and private profile information, and so on. The present invention is limited neither to the amount of information nor to the content thereof maintained for each member of golf club 100.

Exemplary social network services unit 156 implements mechanisms by which community interactions experienced in traditional brick-and-mortar golf clubs are simulated in a virtual setting. Social network services unit 156 enables members to post pictures and videos from golfing events, create and manage golfing events, post general and golf-related status updates, save scorecards and statistics, maintain a golfer profile, list favorite courses and communicate with friends and fellow golfers. Numerous social media features and implementations can be used in conjunction with the present invention without departing from the spirit and intended scope thereof. Additionally, the ordinarily skilled artisan will understand references to such mechanisms as login controls, registration controls, social media controls, among others, without explicit description or illustration thereof. And, while only certain features of a complete social media system will be described herein, it is to be understood that features not described herein may nevertheless be implemented in conjunction with the present invention. Thus, solely in the interest of conciseness, description and illustration of such features will be omitted unless other than conventional mechanisms are to be understood.

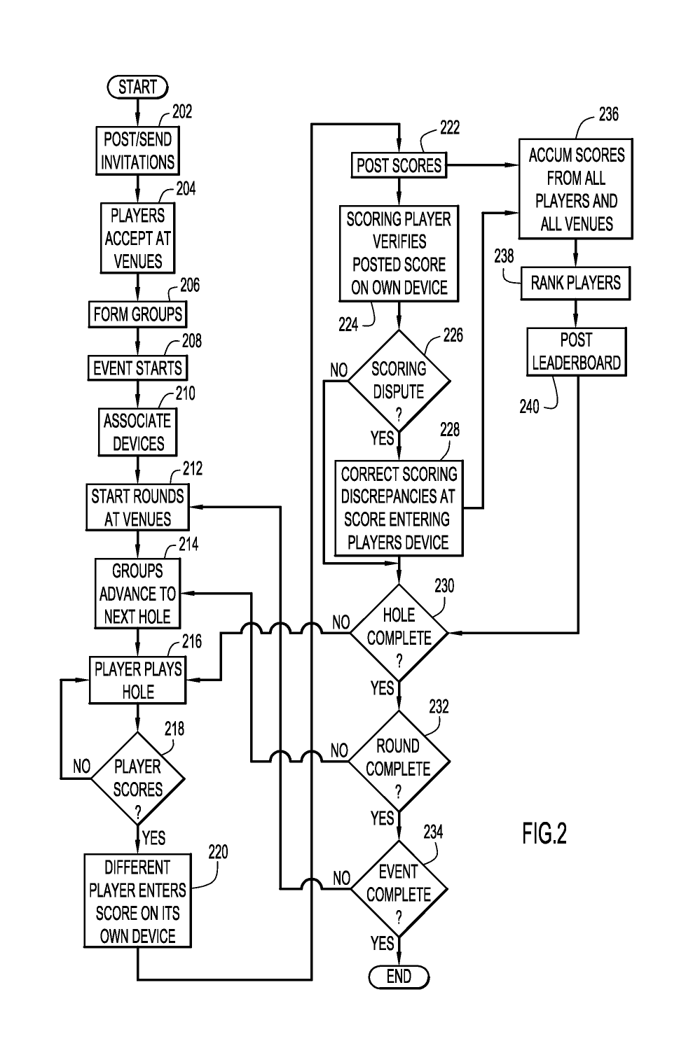

Exemplary game management unit 154 implements management aspects for establishing, scoring, and conducting golf games in different formats concurrently at one or more different venues, e.g., golf courses. Access to game management unit 154 may be given to mobile devices 120 through a mobile app and associated application layer network protocols. An exemplary game management process is described below with reference to FIG. 2.

It is to be understood that member management unit 152, game management unit 154, social network unit 156 and web server 158 are distinguished one from another herein solely for purposes of explanation and not limitation. Indeed, code and/or data may be shared between units to implement seamless and efficient operation. For example, social network unit 156 may rely on web pages of web server 158 to afford social and other interactions between members. Numerous configurations of hardware and software that perform functionality similar to that described herein may be used to practice the present invention without departing from the spirit and intended scope thereof.

Golf club 100 may include a governing body server 170, which may be operated by a sanctioned or accepted official organization, such as the United States Golfers' Association (USGA). Governing body server may include a database containing official rules of play 144 and standardized skill level parameter data 142. Skill level parameter data may include, for example, a standardized handicap index, such as that provided by the Golfer Handicap Index Number (GHIN) service provided by the USGA, that user devices 120 or club server 150 may access to retrieve an official handicap.

FIG. 2 is a flow diagram of an exemplary game management process 200 that may be performed by game management unit 154. In operation 202, a member of golf club 100, designated as a tournament manager, may post invitations to an event, such as a golf tournament, on one or more social network webpages and/or send such invitations via e-mail, texting or some other form of messaging. The invitations may include a start date and time for the tournament as well as a list of venues, e.g., golf courses over which tournament play may be distributed. That is, embodiments of the present invention allow tournaments to be played concurrently at multiple golf courses. In operation 204, players may accept the invitation and choose one of the venues listed in the invitation of the golf course at which the player will compete. In operation 206, competitors and/or tournament managers may assign individual golfers to groups, e.g., teams, pairings, foursomes, etc., in which the golfers will compete.

In operation 208, the event begins at the designated start date and time. In operation 210, mobile devices 120 are credentialed, i.e., associated with a particular user 102. Such may be achieved by an authentication process with member data stored on club server 150, e.g., by entry and verification of a player's username and password. In certain embodiments, a user 102 may log on to club server 150 with user credentials associated with the user's membership account. Upon authentication, that particular user's device is associated with that player. A logged on player need not request subsequent authentication; a cookie or like-purposed mechanism may be stored or implemented on the mobile device 120 to allow user 102 to remain logged on to club server 150 for extended periods of time and, in certain embodiments, to maintain the association to his/her mobile device 120 throughout the event.

The association of a player to his/her mobile device 120 may be such that provides control over what that player can access during a game, e.g., only those game activities that are authorized for the player with which mobile device 120 is associated can be performed on that player's mobile device 120. In certain embodiments, all players are prohibited from entering their own scores, but are allowed to enter the score of other players in his group. Accordingly, each player may interact with golf club 100 in different roles. One such role is that of a scorekeeping player in which the player keeps scores for other players, i.e., players not associated with scorekeeping player's device. Another role is that of a scoring player for which points scored thereby are entered by a different player, i.e., a scorekeeping player. That is, a scoring player cannot be a scorekeeping player for purposes of entering any points for him/herself. It is to be understood that any player can be both a scorekeeping player and a scoring player and such distinction is drawn herein solely for purposes of explanation. The point being made here is that, in certain embodiments of the present invention, no player can enter his/her own score on the mobile device 120 that has been associated with that player. Such prohibition may be realized by asserting read-only access to a player's score on his/her own mobile device 120.

In operation 212, golf rounds are started across all venues and are concurrently played. The tournament rounds are played at the various venues independently of play at other of the venues. However embodiments of the present invention manage the event as a whole regardless of the physical distance between venues. In operation 214, each group advances to play the next hole and in operation 216, a particular player plays that hole.

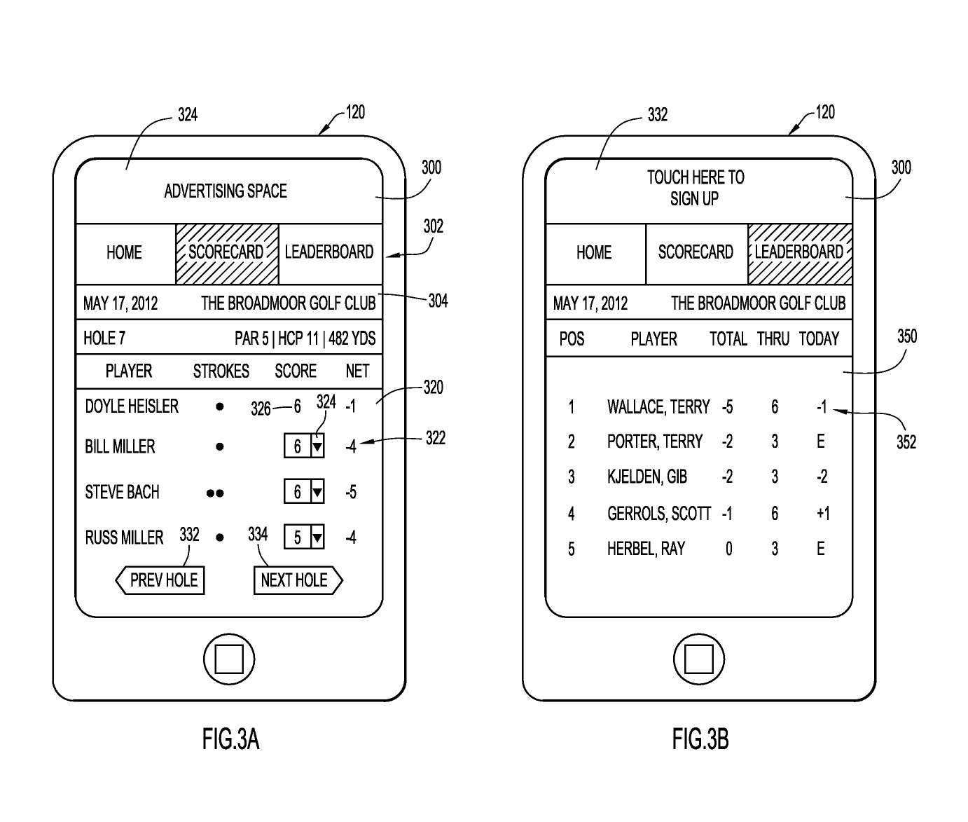

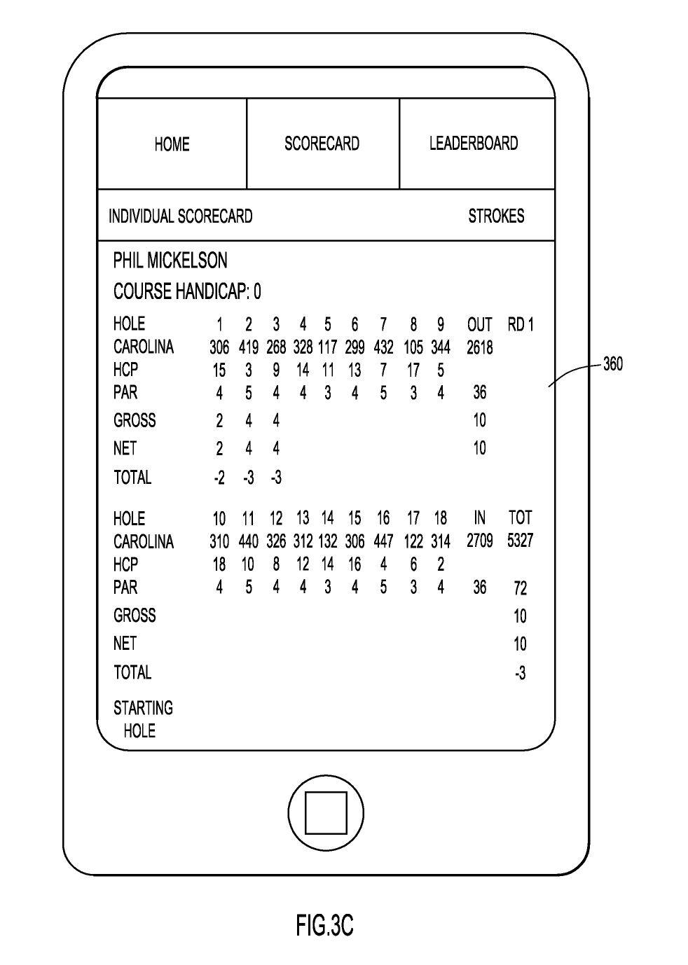

In operation 218, it is determined whether an individual player scores at the golf hole being played. Thus, in operation 220, a player other than the scoring player, i.e., a scorekeeping player enters the scoring player's score through, for example, a user interface on the other player's mobile device 120. Such an interface is illustrated as exemplary user interface 300 in FIGS. 3A-3C, collectively referred to herein as FIG. 3, the description for which is presented below.

The scores entered in operation 220 are posted on, for example, the scorecards of any applicable golfers, in operation 222. In operation 224, the scoring player can verify on his own mobile device 120 whether the score entered by the scorekeeping player is correct. If, in operation 226, the scoring player determines that the score has not been entered correctly, the scoring player and the scorekeeping player may need to resolve the discrepancy. If the original score has been entered correctly or upon resolution of the scoring discrepancies, it is determined in operation 230 whether all golfers have completed the current hole. If not, process 200 transitions back to operation 216 where the next player plays the hole. Once all golfers have completed the hole, it is determined in operation 232 whether the round has been completed. If not, process 200 transitions to operation 214 where the group advances to the next hole in the round. It is then determined in operation 234 whether the event has been completed and, if not, the next rounds of golf in the event are played.

Upon a score being posted in operation 222 or corrected in operation 228, operation 236 evaluates the scores from all the players across all venues. Based on those scores, the players are ranked in operation 238, such as to establish the leading players and, in operation 240, the rankings are posted in a leaderboard format upon demand by mobile devices 120 or at other designated locations.

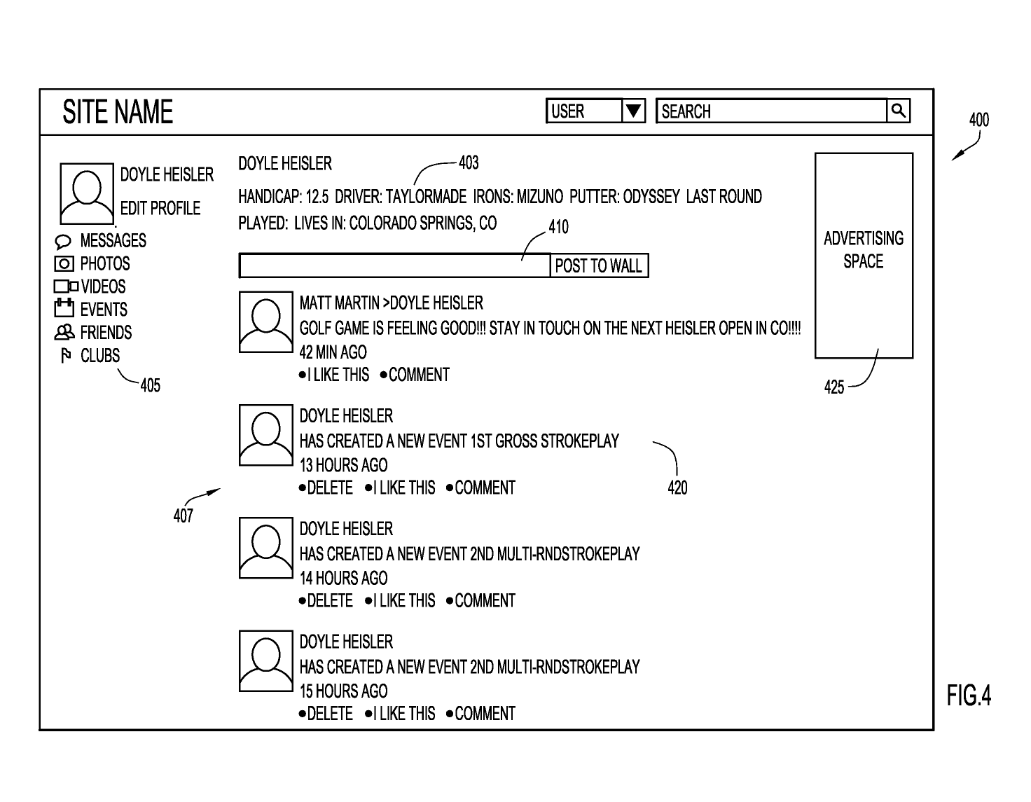

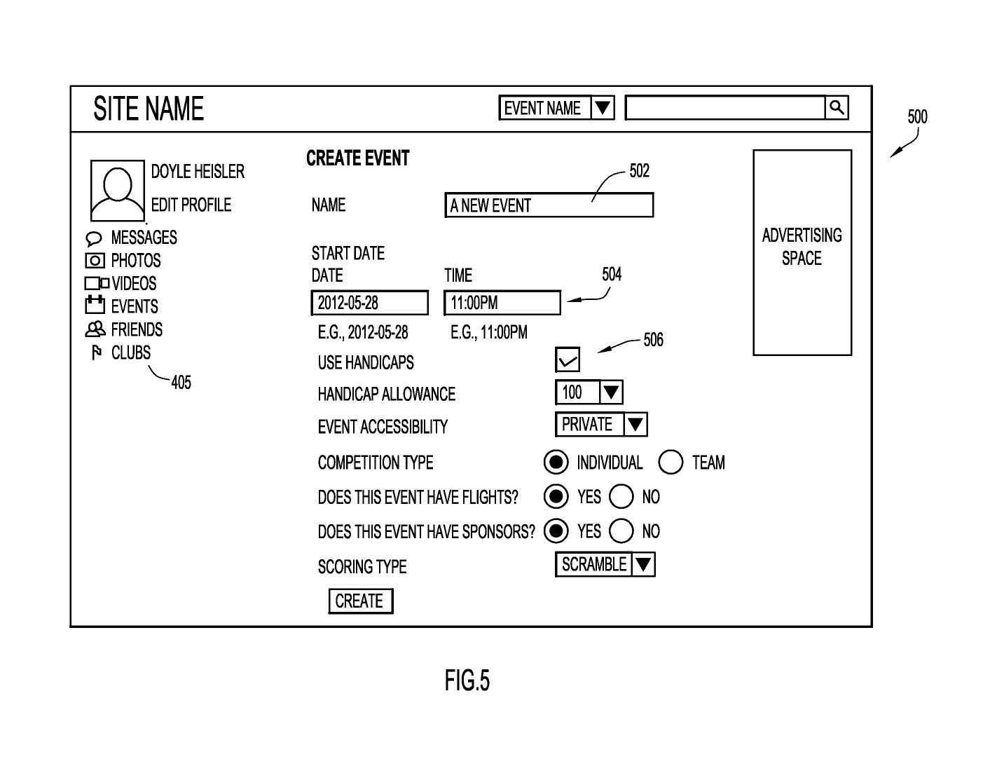

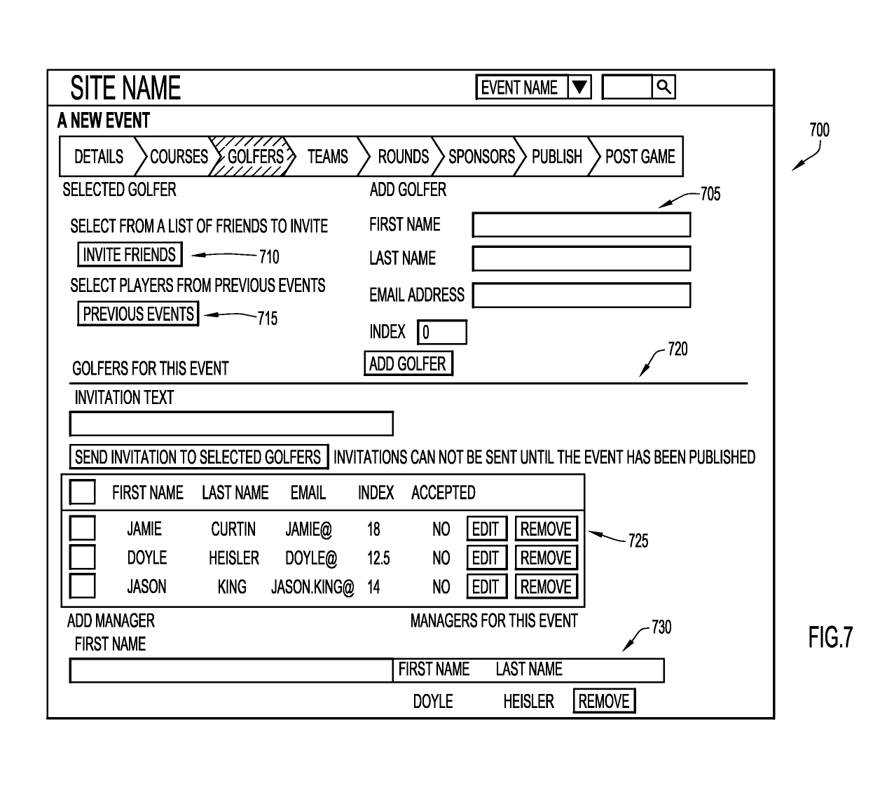

An exemplary user interface 300 for mobile devices 120 is illustrated in FIG. 3. User interface 300 may include several different data entry fields, user controls and data items by which golfers can track their play and that of other golfers. User interface 300 may include tab controls 302 by which the player can alternate between, for example, a home page view, which may provide a social network interface, such as that illustrated in FIG. 4 below, a scorecard interface 320 and a leaderboard interface 350. User interface 300 may include a time and place data field 304 indicating the date and venue at which the associated player is playing. User interface 300 may include hole information field 306 indicating the hole that the associated player is playing, and other information such as par for the current hole, handicap for the hole and distance from the tee to the hole. Additionally, user interface 300 may include advertising space in which sponsors of the event can provide advertisements, such as through sponsor's page 800 described below. A signup control 332 may be included, the activation of which would compel presentation of a suitable player entry control, such as that described below with reference to FIG. 7.

Scorecard interface 320 includes a plurality of scoring data fields that indicate the identities of players in the group, the handicap strokes for each player, player's gross score and the player's net score. A player's net score may be given by the formula,

[net score]=[gross score]−[handicap strokes],

where gross score is typically the number of strokes the corresponding player required to sink the ball at the hole and handicap strokes is the number of strokes deducted from the gross score based on the player's course handicap, which is dependent on the player's handicap index supplied by, for example, the GHIN stored on server 170 operated by the USGA. In certain embodiments of the present invention, a player's handicap index is automatically retrieved from the server 170, e.g., the USGA GHIN server, such as by a Web Application Programming Interface (API). The present invention is not limited to any particular set of calculations for determining players' score and such may vary with established rules or, in certain embodiments, may be a selectable feature of game management unit 154. FIG. 3C is an illustration of an alternative score card presentation control 360, which displays the full hole-by-hole scoring of an individual player.

As illustrated in FIG. 3A, player data field 322 includes a scoring control 324 by which scorekeeping players, i.e., the players in the group that have not been associated with that player's mobile device 120, can enter the score for scoring players in the group. Such control may be a drop down control, as illustrated in the figure, or may be some other data entry field. As discussed above, the player associated with mobile device 120 is prohibited from entering his/her own score and such player's scoring field 326 may be rendered in a read-only mode, such as by non-editable graphics. Such prohibition may be achieved by a suitable read-only access mechanism that may be activated or deactivated in accordance with scorekeeping parameters associated with the event. For example, when the event is to use Official Scoring, i.e., the score maintained on the course through the players' electronic scorecards on each player's mobile device is the official score, a read-only module on each player's mobile device, i.e., the device associated with the player's login credentials, is activated such that each player is prohibited from entering his or her own score on his or her own mobile device.

Exemplary leaderboard interface 350 includes a plurality of player fields 352 that indicate the players' position in the event based on score ranking criteria, players' identity, the players' total score, the hole number through which the score has been determined and the player's present day or round's score. Leaderboard interface 350 may be updated continually, such as by a data push operation which distributes leaderboard information to all mobile devices 120 upon a change in score by any player. In other embodiments, the leaderboard data are retrieved from club server only upon demand, e.g., upon selecting the leaderboard tab in tabs field 302.

Scoring interface 320 and leaderboard interface 350 may include other controls, essentially without limitation. For example, scoring interface 320 may include hole navigation controls 332 and 334 by which the device operating player can select the data entry controls for particular hole. In certain embodiments, a scorekeeping player can navigate to any previously played hole and adjust the score if that score has been disputed by a scoring player. Other embodiments may prohibit such activity and in others rescoring a previous hole may be a manager selectable option.

Various exemplary features of the present invention described above will now be elaborated upon through illustration and description of various web pages utilized throughout golf club 100. User controls in such web pages provide mechanisms by which users can interact socially and competitively over network 140. The present invention may be implemented by a wide variety of control, data transfer and presentation techniques, e.g., by a downloaded application, e.g., a mobile app, and/or by HTTP-based web pages, among others, without departing from the spirit and intended scope of the present invention.

FIG. 4 is an illustration of an exemplary social media member home page 400 that may be configured for a member of golf club 100. Member page 400 includes a member profile information field 403, which displays information about the page owning member to other members and personalizes the page. On web page 400, and elsewhere throughout the club website, advertising space 425 may be provided from which revenue for the site operators can be generated. A wide variety of online advertising types may be used in conjunction with the present invention, such as, for example, banner advertisement, e-mail advertising, in-game advertising, and keyword advertising.

Member page 400 may allow other members to post to the page owning member's wall 407 through a posting control 410. Other appropriate social media pages and/or social media controls may be implemented as well, such as status updates, like/dislike, post commenting, and so on. Additionally, controls may allow the page owning member to collect and post various other items, as illustrated in menu 405, including photos, videos and friends.

Members of golf club 100 are afforded resources by which information specific to golf can be disseminated and discussed by club members. For example, member profiles may include information such as the member's handicap, the member's favorite driver, irons, putter, etc., the date and location of the member's last played round, the member's home course, the member's drive distance, the member's favorite golfer, the number of rounds the member plays per year, the member's dream golf vacation, information regarding the round the member played that is farthest from the member's home, the member's favorite golf book or movie, among others. Updates may be selectively generated and provided to members when, during a round, a player shoots birdies, eagles and holes-in-one.

As discussed above, the present invention affords resources by which various events can be managed. For example, field 420 in FIG. 4 illustrates that a member, in this case the page-owning member, has created a virtual golfing event entitled, “1^{st} Gross StrokePlay.” Other members can, accordingly, take appropriate action based on the post. For example, members may be provided with a hyperlink that loads a page devoted to a “1^{st} Gross StrokePlay” tournament page where the player can register to play, make comments, and so on.

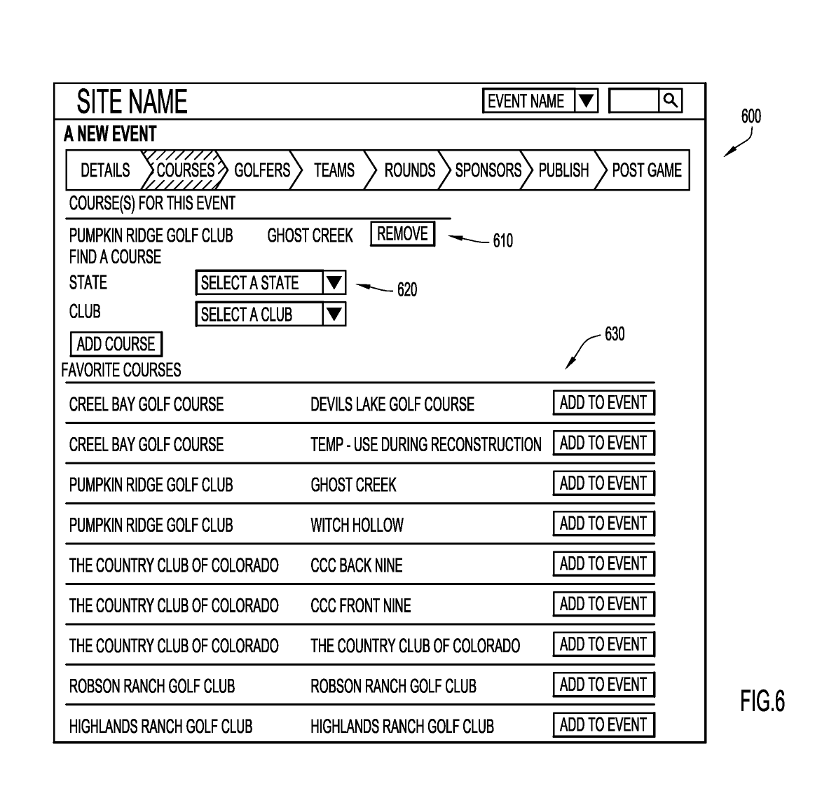

FIG. 5 is an illustration of an event creation web page 500. In data entry field 502, the user may enter an event name and set a time and date for the event in fields 504. Other fields 506 may be implemented to define parameters on which the event is to be played. For example, controls may be provided to establish whether handicaps are allowed and, if so, the handicap that is allowed, the accessibility of the event, e.g., whether the event is publicly or privately posted, the competition type, e.g., whether the competition is established for individual or team play, establish if flights will be formed for the event, whether the event is sponsored and the scoring format, e.g., scramble, stroke play, best ball, Stableford, etc. Controls for other event parameters may be implemented as well, such as, for example, whether the event has volunteers, whether there is an entry fee, etc.

FIG. 6 is an illustration of a golf course selection web page 600 by which an event manager can define courses on which the event will be played. Currently selected courses may be displayed in field 610 and additional courses may be selected through course search control 620 and favorite courses control 630. As stated above, an event can be conducted over multiple venues; courses may be added and/or deleted from an event through exemplary golf course selection web page 600.

FIG. 7 is an illustration of a golfer invitation webpage 700 by which specific golfers may be invited to the event. Nonmember, guest golfers may be added to the event through data entry fields 705, member golfers may be invited from a user-defined friends list by activating invite friends control 710, and players from previous events may be selected by activating previous events control 750. A list of golfers currently selected for play in the event may be presented in fields 725 and specially composed text for the invitation itself may be entered in text entry field 720. One or more golfers or other users may be given manager access rights to the event via manager addition control 730. Similar webpages (not illustrated) and controls may be used to provide additional golfer management, such as to create teams and pairings.

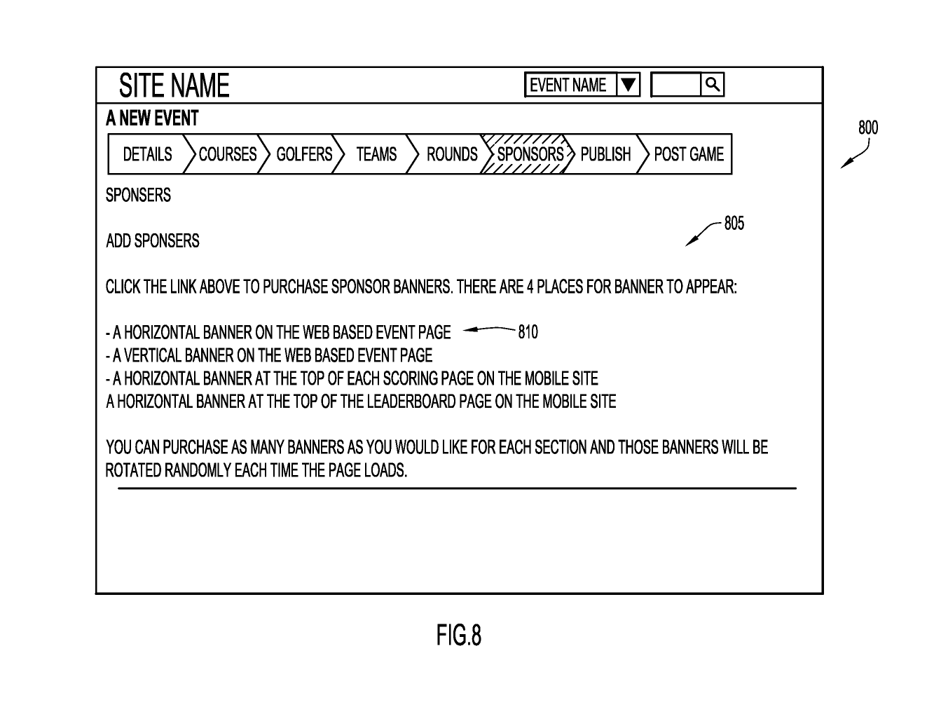

FIG. 8 is an illustration of an exemplary sponsors' web page 800 through which event sponsors can purchase advertising space. Whether an event is sponsored may be established by the sponsor control in event creation web page 500 illustrated in FIG. 5, which when affirmed through the “Yes” control, sponsors may be invited to sponsor an event. Such invitation may be achieved by a suitable sponsor's event page (not illustrated) by which different sponsors can be added to the event. Each of added sponsor may then be notified, such as by email, that the event is scheduled and may point the potential sponsor to sponsors' web page 800.

Sponsors' page 800 may list different advertising options 805 and each option 805 may be associated with a hyperlink that directs the sponsor to a purchase page (not illustrated). On the purchase page, the purchasing sponsor provide additional information, such as company name, website address, and a banner image to be used in the advertising space selected from options 805.

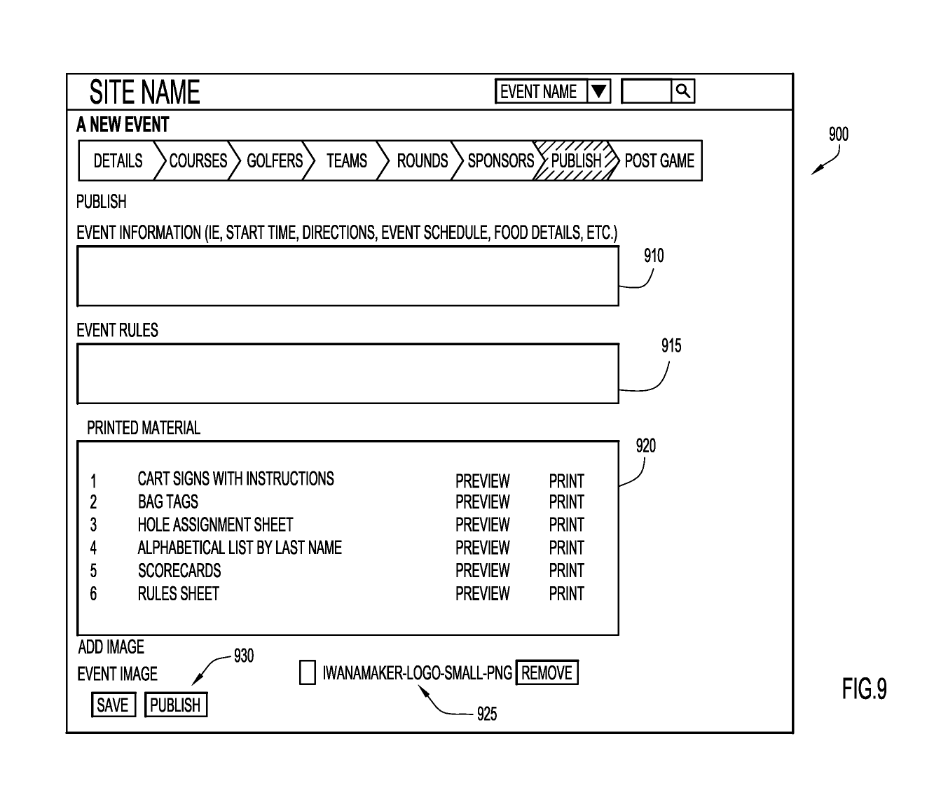

FIG. 9 is an illustration of an exemplary event information publishing web page 900 through which details of the event may be published to potential competitors or other interested parties. Publish web page 900 provides may include an event information entry field 910, by which an event manager can include useful information, such as directions, dining choices, etc., and an event rules entry field 915, to include, for example, rules of conduct for players in the event, etc A list of printed material 920 may be provided by which the player can preview and/or print various information sheets. An event logo or other image associated with the event may be specified, e.g., by file location, by event image control 925. Upon activation of publish control 930, invitations containing the information in publish web page 900 may be disseminated by email, by posting social media notifications and by other suitable notification techniques.

Certain embodiments of the present general inventive concept provide for the functional components to manufactured, transported, marketed and/or sold as processor instructions encoded on computer-readable media. The present general inventive concept, when so embodied, can be practiced regardless of the processing platform on which the processor instructions are executed and regardless of the manner by which the processor instructions are encoded on the computer-readable medium.

It is to be understood that the computer-readable medium described above may be any non-transitory medium on which the instructions may be encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above.

The descriptions above are intended to illustrate possible implementations of the present inventive concept and are not restrictive. Many variations, modifications and alternatives will become apparent to the skilled artisan upon review of this disclosure. For example, components equivalent to those shown and described may be substituted therefore, elements and methods individually described may be combined, and elements described as discrete may be distributed across many components. The scope of the invention should therefore be determined not with reference to the description above, but with reference to the appended claims, along with their full range of equivalents.

What is claimed is:

1. A method comprising:
associating, by a server device, a plurality of user devices with respective players of a competitive activity, the server device being communicatively coupled to the user devices through respective communication channels in a communications network;
accepting, by only those user devices not associated with a scoring player, input of one or more points scored by the scoring player;
receiving, by the server device from the user devices, the points scored by the players as accepted by the user devices not associated with the scoring player;
accumulating, by the server device, the points scored by the players as received from the user devices;
determining, by the server device, rankings of the respective players from the accumulated scores; and
displaying, upon demand by at least one of the user devices, the rankings of the respective players.

2. The method of claim 1, further comprising:
accepting, through user controls on a user device, input of identifiers of venues at which one or more rounds of the competitive activity are played concurrently one with another.

3. The method of claim 2, further comprising:
selecting by the user controls on the user device a venue from a list of venues;
associating the player identification data with the selected venue;
accepting game data from the user device associated with the player at the selected venue.

4. The method of claim 1, wherein the accumulating of the points scored and the determining of the rankings are performed responsive to the receiving of the points scored from any of the user devices such that the displaying of the rankings reflects current rankings of the players in the competitive activity at the time the displaying was demanded by any of the user devices.

5. The method of claim 1, wherein associating the user devices with the respective players further comprises:
entering, by one of the user devices, an identity of one of the players;
authenticating the entered identity of the player by stored identification data therefor; and
storing association data indicative of an association of the authenticated identity of the player with the user device with which the identity of the player was entered.

6. The method of claim 5 further comprising:
prohibiting, by the server device, acceptance of the points scored by the scoring player from any of the user devices for which the association data is not stored.

7. The method of claim 1, further comprising:
associating, by the server device, the players with membership data indicative of registered membership of users in a social media network;
selecting the players from the registered members of the social network;
conveying information regarding the event to the selected players through the social media network.

8. An apparatus comprising:
a network interface communicatively coupled to a communication network to convey competitive activity data over the communication network;
a storage device to store user controls retrievable by external user devices through the network interface, the user controls being configured to:
accept identification data of respective players in the competitive activity; and
accept input of one or more points scored by a scoring one of the players by only those user devices not associated therewith; and
a processor communicatively coupled to the network interface and the storage device and configured to:
associate the user devices with the respective players of the competitive activity;
receive the points scored from the user devices not associated with the scoring player;
accumulate the received points scored;
determine rankings of the respective players from the accumulated scores; and
provide to the communication network through the network interface the rankings of the respective players.

9. The apparatus of claim 8, wherein the user controls include:
a venue control to accept input of identifiers of venues at which one or more rounds of the competitive activity are played concurrently one with another.

10. The apparatus of claim 9, wherein the user controls include:
a venue list control to list the identifiers of the venues;
a venue selection control by which a venue is selected from the list of venues;
accept game data from the user device associated with the player identification data at the selected venue;
and the processor is configured to:
associate the player identification data with the selected venue.

11. The apparatus of claim 8, wherein the processor is configured to:
receive a request for the rankings;
accumulate the points scored and to determine therefrom the rankings responsive to the receiving of the points scored from any of the user devices such that the rankings provided to the communication network reflects current rankings of the players in the competitive activity as of the time the rankings were requested by any of the user devices.

12. The apparatus of claim 8, wherein the processor is configured to:
receive access credentials by one of the players;
authenticate the access credentials of the player by the identification data corresponding to the player stored in the storage unit; and
generate association data indicative of an association of the authenticated access credential of the player with the user device with which the access credentials of the player was entered.

13. The apparatus of claim 12, wherein the processor is configured to:
transmit, through the network interface, the association data to the user device with which the access credentials of the player was entered.

14. The apparatus of claim 13, wherein the association data is a hypertext transfer protocol cookie.

15. The apparatus of claim 13, wherein the processor is configured to:
prohibit accumulation of the points scored by the scoring player from any of the user devices for which the association data is not stored.

16. The apparatus of claim 8, wherein:
the storage unit has stored therein membership data indicative of registered membership of users in a social media network,
the user controls include a member selection control by which the players are selected from the registered members of the social network, and
the processor is configured to convey information regarding the competitive activity to the selected players through the social media network.

17. The apparatus of claim 8, wherein the user controls include:
a scoring control comprising a data entry field for a plurality of the players and a read-only data field to present the scored points of the player associated with the user device on which the scoring control is presented.

18. The apparatus of claim 8, wherein the storage unit has stored therein processor instructions that, when executed by an external processor on one of the user devices, configures the external processor to:
present a scoring control on a display device, the scoring control comprising a data entry field for a plurality of the players and a read-only data field to present the scored points of the player associated with the user device on which the processor instructions are executed.

19. A tangible non-transitory computer readable medium or media having encoded thereon instructions that, when executed by a processor, configure the processor to:
associate a plurality of user devices with respective players of a competitive activity;
receive, over a communication network, points scored by the players as accepted by the user devices not associated with a scoring player;
accumulate the points scored by the players as received from the user devices;
determine rankings of the respective players from the accumulated scores; and
providing the rankings to at least one of the user devices upon demand therefor.

20. The tangible non-transitory computer readable medium or media of claim 19, wherein the instructions configure the processor to:
receive input of identifiers of venues at which one or more rounds of the competitive activity are played concurrently one with another.

21. The tangible non-transitory computer readable medium or media of claim 14, wherein the instructions configure the processor to accumulate of the points scored and determine the rankings responsive to a request therefor received via the communication network, to the receiving of the points scored from any of the user devices such that the displaying of the rankings reflects current rankings of the players in the competitive activity at the time the displaying was demanded by any of the user devices.

22. The tangible non-transitory computer readable medium or media of claim 14, wherein the instructions configure the processor to:
receive access credentials by one of the players;
authenticate the access credentials of the player by previously stored identification data corresponding to the player; and
generate association data indicative of an association of the authenticated access credential of the player with the user device with which the access credentials of the player was entered.

23. The tangible non-transitory computer readable medium or media of claim 14, wherein the instructions configure the processor to:
prohibit accumulation of the points scored by the scoring player from any of the user devices for which the association data is not generated.

24. The tangible non-transitory computer readable medium or media of claim 14, wherein the instructions configure the processor to:
generate a scoring control comprising a data entry field for a plurality of the players and a read-only data field to present the scored points of the player associated with the user device on which the scoring control is presented.
